(19) United States
(12) Patent Application Publication
(10) Pub. No.: US 2010/0067834 A1
(43) Pub. Date: Mar. 18, 2010

(54) HYDROSTATIC PROFILE RAIL GUIDE

(75) Inventors: Martin Menges, Homburg (DE); Wolfgang Bauer, Riegelsberg (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/559,729

(22) Filed: Sep. 15, 2009

(30) Foreign Application Priority Data
Sep. 16, 2008 (DE) 10 2008 047 298.0

(51) Int. Cl. F16C 32/06

(52) U.S. Cl. 384/12

(57) ABSTRACT

A hydrostatic profile rail guide, which has a guide carriage mounted hydrostatically on a guide rail designed with a U-shaped cross-section, pressure pockets for building up hydrostatic pressure between the guide carriage and rail, gaps connected to the pressure pockets for hydraulic fluid, a drainage for hydraulic fluid emerging from the gaps, and a seal surrounding the drainage and arranged between the guide carriage and rail which has side and head portions. At least one of the side portions of the seal is arranged between each leg of the guide carriage and rail, and at least one of the head portions of the seal is arranged transversely to the guide rail on both head sides of the guide carriage. The side portions of the seal are formed by side seals arranged on the guide rail and the head portions are formed by head seals arranged on the guide carriage.

### FIELD OF THE INVENTION

The present invention relates to a hydrostatic profile rail guide in which a guide carriage is mounted hydrostatically on a guide rail.

A hydrostatic profile rail guide has become known, for example, from WO 2004/020852 A1, in which a guide rail designed with an approximately T-shaped cross-section is surrounded by the guide carriage. The guide carriage has a back and legs located on both sides of the guide rail and adjoining the back in one piece, so that the guide carriage has an approximately U-shaped cross-sectional profile. The free ends of each leg are provided with screw-on flanges which spring toward one another so that the T-shaped guide rail is surrounded.

In these known hydrostatic profile rail guides, pressure pockets for building up a hydrostatic pressure between the guide rail and the guide carriage are provided in a known way on said guide carriage. Hydraulic fluid is pumped into the pressure pockets via an external pump, so that a pressure cushion is built up between the guide carriage and the guide rail. The hydraulic fluid flows out via gaps which are connected hydraulically to the pressure pockets. The gaps are delimited by gap faces which are formed on the guide carriage and on the guide rail.

Furthermore, this known hydrostatic profile rail guide is provided with a drainage in order to receive hydraulic fluid emerging from the gaps. The drainage is connected to a return duct or a reservoir so that the hydraulic fluid can be supplied to the pump again and pumped anew into the pressure pockets of the hydrostatic profile rail guides.

Furthermore, a seal is provided, which ensures that this known hydrostatic profile rail guide is oil-tight. This seal is arranged effectively between the guide carriage and the guide rail and has side portions and head portions. In each case at least one of the side portions of the seal which extend along the guide rail is arranged between each leg of the guide carriage and the guide rail. In each case, at least one of the head portions of the seal is arranged transversely to the guide rail on both head sides of the guide carriage. This seal ensures that no oil escapes undesirably even when the pump is switched off and the hydrostatic profile rail guide is at a standstill.

The side portions and the head portions of the seal must cooperate with one another such that the oil-tightness described is ensured. Various proposals as to a technical solution have been made toward this. Thus, it has been proposed to glue to one another or press against one another mutually adjacent ends of the head portions and of the side portions of the seal or to produce a seal entirely in one piece. However, all these technical solutions are complicated, oil-tightness remaining challenging at the transition between the head portion and the side portion of the seal.

The object of the present invention is to specify a hydrostatic profile rail guide according to the precharacterizing clause of Claim 1, in which the escape of hydraulic fluid from the hydrostatic profile rail guide is ruled out in a simple way, or, in other words, in which oil-tightness is ensured.

According to the invention, this object is achieved by means of the hydrostatic profile rail guide according to Claim 1. Since the side portions of the seal are formed by side seals arranged on the guide rail and the head portions of the seal are formed by head seals arranged on the guide carriage, the problem of the connection of ends of the head seal and of the side seal is avoided. It was found that sliding contact is sufficient for oil-tightness precisely at the transition between the side seals and the head seal.

A further advantage of the invention may be seen in that it is no longer necessary to provide side portions of the seal on the guide carriage. The guide carriage can consequently be produced more simply, since, for example, grooves for the reception of sealing cords are dispensed with. Omitting the side portions of the seal on the guide carriage affords a further advantage from another aspect; hydrostatic profile rail guides are often used alternatively to rolling profile rail guides. This means that hydrostatic profile rail guides have to be produced in the standard construction space of rolling profile rail guides. DIN 645-1 provides standardized construction series of which the largest are 15, 20, 25, 30, 35, 45, 55, 65. In the smaller construction series of 15 to about 30, the available space for forming the pressure pockets and the gaps connected to the pressure pockets and for drainage is very limited because of the small spatial dimensions. The omission, for example, of a groove designed for receiving a side seal on the guide carriage, therefore means that there is additional construction space, for example, for enlarging the pressure pockets.

In the hydrostatic profile rail guide according to the invention, each gap can be delimited in a known way by gap faces of the guide carriage and of the guide rail.

Preferably, the two legs of the guide carriage are in each case provided at their free ends with a sealing face which faces the guide rail and extends between the two axial ends of the leg and against which the assigned side seal bears. In a similar way to a lip seal, here too, oil-tight contact between the side seal and the sealing face of the leg is ensured. The side seal may be designed as a sealing cord or else as a lip seal.

Guide rails for hydrostatic profile rail guides according to the invention preferably have an approximately anvil-shaped rail head, there being formed between the rail head and a rail foot a contracted foot portion, as far as which the free end of the leg of the guide carriage reaches when the guide carriage is pushed onto the guide rail. In this case, the foot portion of the guide rail is provided with the side seal according to the invention. The side seal extends along the guide rail over the entire travel of the guide carriage.

For the satisfactory positioning and reliable holding of the side seal, the guide rail may be provided with longitudinal grooves for receiving the side seal.

In a hydrostatic profile rail guide according to the invention, the seal may be formed preferably from two longitudinal seals and two head seals, the head seals adjoining the longitudinal seals and forming a seal arranged around the drainage and closed so as to be fluid-tight.

The invention is explained in more detail below by means of an exemplary embodiment depicted in a total of four figures in which:

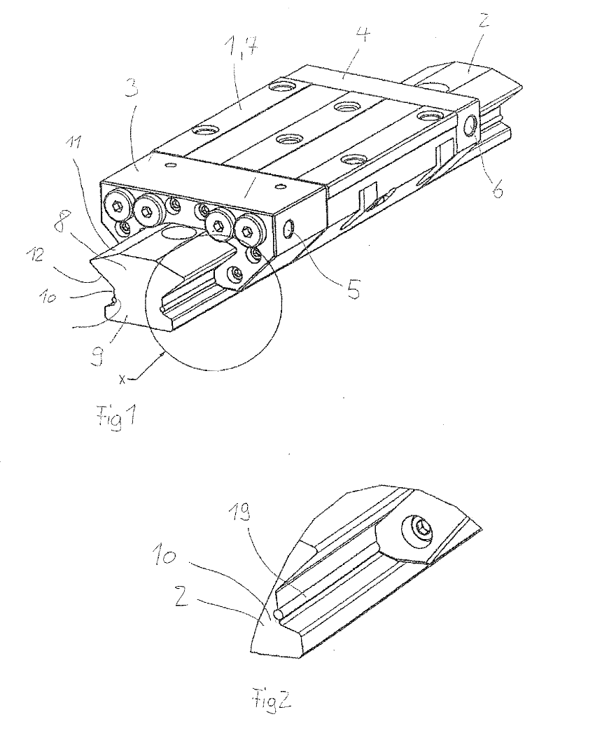

FIG. 1 shows a hydrostatic profile rail guide according to the invention in a perspective illustration;

FIG. 2 shows an enlargement from FIG. 1 in the form of a detail;

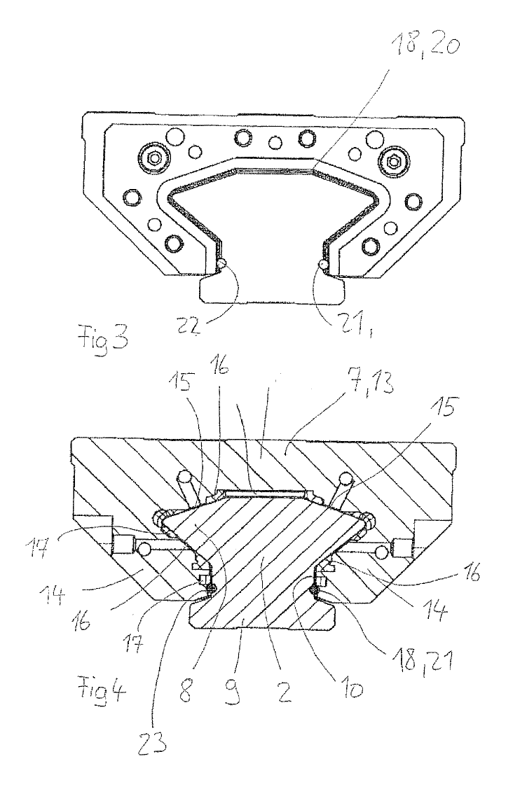

FIG. 3 shows a view of the hydrostatic profile rail guide according to the invention with the head seal exposed; and

FIG. 4 shows a cross section through the hydrostatic profile rail guide from FIG. 1.

FIG. 1 shows a perspective illustration of a hydrostatic profile rail guide according to the invention. A guide carriage 1 is mounted hydrostatically on a guide rail 2. The guide carriage 1 is provided with a head piece 3, 4 on each of its two end faces, the head piece 3 being provided with a pressure connection 5 and the head piece 4 with a suction connection 6 for hydraulic fluid. Via a pump, not depicted here, the hydraulic fluid can be pumped via the pressure connection 5 into the head piece 3 and from there via valves, likewise not depicted, into a carrying body 7 of the guide carriage 1. The hydraulic fluid is sucked away from the guide carriage 1 via the suction connection 6 and is supplied anew to the pump, not depicted here.

The guide rail 2 has an approximately anvil-shaped rail head 8 and a rail foot 9, a contracted foot portion 10 being formed between the rail foot 9 and the rail head 8. The rail head 8 is provided on its two longitudinal sides in each case with two bearing faces 11, 12 which are arranged at an acute angle to one another and which extend along the longitudinal axis of the guide rail 2.

It may be gathered from FIG. 4 that the carrying body 7 has a back 13 and two legs 14 arranged parallel to and at a distance from one another, the carrying body 7 partially surrounding with its two legs 14 the guide rail 2. The carrying body 7 is provided, on its inner faces lying opposite the bearing faces 11, 12 of the guide rail 2, in each case, with a pressure pocket 15 which extends along the carrying body 7. Gaps 16 are connected hydraulically to these pressure pockets 15. A hydrostatic pressure is built up via the pressure pockets 15 between the guide carriage 1 and the guide rail 2. The hydraulic fluid put under pressure in this way flows out via the gaps 16 along with a pressure drop, and finally, approximately pressureless, leaves the gap 16. The hydraulic fluid, after emerging from the gaps 16, finally enters a drainage 17, so that all the pressure pockets 15 are connected to the drainage 17. The hydraulic fluid is sucked away via the drainage 17 into the head piece 4 and from there via the suction connection 6 out of the guide carriage 1.

In order to ensure that the hydraulic fluid can circulate in a closed circuit, the hydrostatic profile rail guide according to the invention is provided with a seal 18. This seal 18 is of continuous design, in that the seal 18 completely surrounds the drainage 17. Here, surround is understood to mean that the hydraulic fluid can leave the drainage solely via the paths provided and therefore does not leak out of the hydrostatic profile rail guide undesirably.

The seal 18 according to the invention is composed of side seals 19 and head seals 20. It may be gathered particularly from FIGS. 1 and 4 that the guide rail 2 is provided in the foot portion 10 with one of the side seals 19 each on the two longitudinal sides of the guide rail 2.

In the exemplary embodiment, the side seal 19 is formed by a cord seal which is received in a longitudinal groove 21 formed in the foot portion 10 of the guide rail 2. These side seals 19 extend over the entire travel of the guide carriage 1.

The two head seals 20 are arranged in the guide carriage 1, specifically in one of the two head pieces 3, 4, each. FIG. 3 shows an exposed head seal 20 which surrounds, liquid-tight, the guide rail 2 and bears against the latter, the head seal 20 being provided at a transition to the longitudinal seal 21 with a recess 22 adapted to the outer contour of the longitudinal seal 21.

FIG. 2 shows clearly an enlargement in the form of a detail with the arrangement of the side seal 19 in the foot portion 10 of the guide rail 2.

It may be gathered, furthermore, from FIG. 4 that the two legs 14 of the guide carriage 1 bear, liquid-tight, at their free ends, in each case with a sealing face 23 against the side seal 19. This sealing face 23 extends from one head seal 20 as far as the opposite head seal 20. The sealing face 23 is likewise adapted to the contour of the side seal 19.

### LIST OF REFERENCE NUMERALS

1 Guide carriage
2 Guide rail
3 Head piece
4 Head piece
5 Pressure connection
6 Suction connection
7 Carrying body
8 Rail head
9 Rail foot
10 Foot portion
11 Bearing face
12 Bearing face
13 Back
14 Leg
15 Pressure pocket
16 Gap
17 Drainage
18 Seal
19 Side seal
20 Head seals
21 Longitudinal groove
22 Recess
23 Sealing face

1. A hydrostatic profile rail guide, comprising:
a guide carriage, which is mounted hydrostatically on a guide rail, having a U-shaped cross-section, a back and two legs partially surrounding the guide rail;
pressure pockets for building up a hydrostatic pressure between the guide rail and the guide carriage;
gaps, connected to the pressure pockets, for hydraulic fluid;
a drainage for the hydraulic fluid emerging from the gaps; and
a seal surrounding the drainage arranged effectively between the guide carriage and the guide rail, the seal having side portions and head portions, in each case at least one of the side portions of the seal, which extend along the guide rail, being arranged between each leg of the guide carriage and the guide rail, and in each case at least one of the head portions of the seal being arranged transversely to the guide rail on both head sides of the guide carriage,
wherein the side portions of the seal are formed by side seals arranged on the guide rail and the head portions are formed by head seals arranged on the guide carriage.

2. The hydrostatic profile rail guide of claim 1, wherein the leg of the guide carriage bears at its free end, with a sealing face facing the guide rail and extending between two axial ends of the leg, against the side seals.

3. The hydrostatic profile rail guide of claim 1, wherein the guide rail is provided on two longitudinal sides in a foot region, in each case, with one of the side seals.

4. The hydrostatic profile rail guide of claim 3, wherein the guide rail has a longitudinal groove or longitudinal grooves for receiving the side seals.

5. The hydrostatic profile rail guide of claim 1, wherein each of the head seals bears with their ends against one of the side seals.

6. The hydrostatic profile rail guide of claim 1, wherein the seal is formed from two of the side seals and two of the head seals, the head seals adjoining the side seals and forming a closed seal arranged around the drainage.
